(19) United States
(12) Patent Application Publication
(10) Pub. No.: US 2003/0208938 A1
(43) Pub. Date: Nov. 13, 2003

(54) Ceiling tile display

(76) Inventors: Tracy Cink, Richardson, TX (US); Edouard D. Gregory, Dallas, TX (US)

Correspondence Address: Gardere Wynne Sewell, LLP, Suite 3000, 3000 Thanksgiving Tower, 1601 Elm Street, Sallas, TX, 75201-4767, US

(21) Appl. No.: 10/140,712

(22) Filed: May 8, 2002

(51) Int. Cl. G09F 7/22; G09F 13/00

(52) U.S. Cl. 40/617; 40/553

(57) ABSTRACT

The present invention is a ceiling display that has a generally rectangular panel. A lip is attached generally around a portion of the perimeter of the panel. The lip is receivable by the grid of a suspended ceiling. An advertisement attached to the panel serves to promote the attributes of a product.

The present invention relates to advertising displays and, more particularly to, an improved advertising display that is easily installed in a grid of a suspended ceiling.

### BACKGROUND OF THE INVENTION

The goal of advertising is to make potential consumers aware of the attributes of a product and convert the potential consumer into a customer. If the advertiser is successful, the consumer will perceive that the product will fulfill the consumer's needs and consequently prompt the consumer to purchase the product. Advertisers spend billions of dollars each year targeting potential consumers that have needs that the advertisers' products will fulfill. Needs of the consumers, however, are usually difficult to define and even more difficult to track. For example, soft drink advertisers may have difficulty predicting when a consumer will be thirsty and if a consumer will be satisfied by the taste of their particular soft drink. One technique to avoid the difficulty of predicting consumers' needs is point of sale (POS) advertising.

POS advertisements target a consumer that is in a retail location and is likely making other purchases. POS advertisements serve to “remind” a consumer of a need that may be readily fulfilled. Because the consumer is likely purchasing other products POS advertisements prompt the consumer to add the advertised product to their other purchases. The incremental increase in the cost of the whole purchase is outweighed by the convenience and satisfaction provided by the advertised product.

One challenge that advertisers have in presenting their POS advertisement to the potential consumer is the saturation of available space with competitors' advertisements. A quick survey of the register counter in virtually any convenience store makes this challenge instantly apparent. Advertisements fill almost every square centimeter of shopping cart handles, display racks, change trays, the surface of the counter and even the markers that separate one consumer's purchases from another's purchases. This barrage of advertisement has essentially numbed many consumers into ignoring advertisements in expected places. Advertisers, consequently, expend countless hours to develop new, eye-catching space in which to advertise their products.

One space that is naturally appealing to consumers is ceiling space. Many stores have used permanent signs in their ceilings to indicate general locations of products. A ceiling location is particularly effective because of the human tendency to elevate their vision when trying to locate an object. Objects may be more easily found if the consumer gains a wider perspective on their surroundings. Additionally, because most other advertisements are located at eye-level, consumers notice ceiling advertisements because they are differentiated from the ignored clutter of advertisements at eye-level.

As mentioned above, stores have used signs hung from the ceiling to identify product locations. Most of these signs are permanently mounted to the ceiling and costly to manufacture and install. Signs of this type would be cost prohibitive for advertising, especially considering that advertisements are frequently changed to retain consumer interest. Permanent installations also prohibit movement of the sign to accommodate relocating the product to a more desirable place in the store.

Other types of ceiling advertisement use clips or wire to hang signs from the grids of suspended ceilings. These advertisements are difficult to install because required hardware, which is separate from the advertisement display, may be lost or broken. Manufacturing costs of these advertisements are also increased because of the necessary hardware. Furthermore, trained technicians may be required to install the advertisements, which further increases costs. If the advertisements are difficult to install, they may be equally difficult to remove, which hinders the ability to frequently change advertisements.

It would, therefore, be desirable to have an improved ceiling advertisement that catches consumer attention. It would also be desirable to have an improved ceiling advertisement that is not as costly as conventional ceiling advertisements. Further, it would be desirable to have an improved ceiling advertisement that is not difficult or costly to install and remove.

### SUMMARY OF THE INVENTION

The present invention is a ceiling display that has a generally rectangular panel. A lip is attached generally around a portion of the perimeter of the panel. The lip is receivable by the grid of a suspended ceiling. An advertisement attached to the panel serves to promote the attributes of a product.

In one embodiment of the invention, an advertising system has a suspended ceiling that has one or more ceiling tiles suspended by a grid and a ceiling display. A lip attached to the ceiling display removably attaches the ceiling display to the grid.

In another embodiment of the invention, a ceiling display has a generally rectangular, foldable center section. A lip is attached to and extends from a first edge and a second edge of the center section. The first edge is opposite the second edge. A first end section is attached to a third edge of the center section and a second end section is attached to a fourth edge of the center section.

### BRIEF DESCRIPTION OF THE DRAWINGS

For a more complete understanding of the present invention, including its features and advantages, reference is now made to the detailed description of the preferred embodiments, taken in conjunction with the accompanying drawings of which:

FIG. 1 is a plan view of an unassembled ceiling display that depicts an embodiment of the present invention;

FIG. 2A is a perspective view of a ceiling display that depicts an embodiment of the present invention;

FIG. 2B is a perspective view of a ceiling display that depicts an embodiment of the present invention;

FIG. 2C is a plan view of a ceiling display that depicts an embodiment of the present invention;

FIG. 3A is a perspective view of a ceiling display that depicts an embodiment of the present invention;

FIG. 3B is a perspective view of a ceiling display that depicts an embodiment of the present invention;

FIG. 3C is a perspective view of a ceiling display that depicts an embodiment of the present invention;

FIG. 4 is a perspective view of a ceiling display that depicts an embodiment of the present invention; and

FIG. 5 is a cutaway view of an installed ceiling display that depicts an embodiment of the present invention.

### DETAILED DESCRIPTION OF THE INVENTION

While the making and using of various embodiments of the present invention is discussed in detail below, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

A ceiling tile display according to an embodiment of the present invention has many desirable features believed to be previously unavailable to those in the business of advertising. Although ceiling advertisements were known, economical ceiling advertisements that are easily installed and removed are not believed to be available. As will be described in more detail with reference to the figures, one embodiment of the present invention comprises inexpensive ceiling display tiles that are easily installed in and removed from the ceiling by untrained personnel.

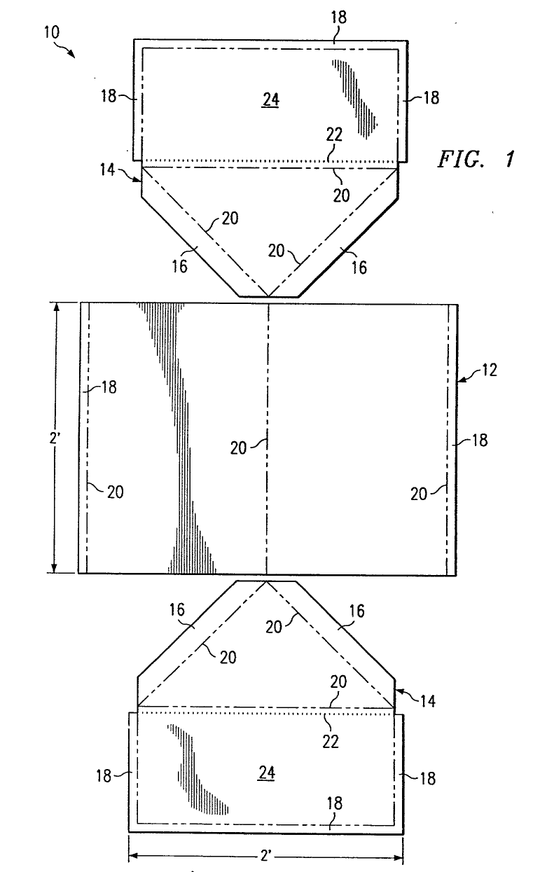

Referring now to the figures and, in particular to FIG. 1, a ceiling display 10 in an unassembled form is depicted. The ceiling display 10 may be fabricated from die-cut corrugated cardboard, corrugated plastic sheet stock and the like. Ceiling displays 10 made from inexpensive materials are usually less expensive to manufacture and are easily disposable. More substantial materials, however, may also be used to make the ceiling display 10. For example, aluminum, carbon fiber composites and the like may also be used to fabricated the ceiling display 10.

The ceiling display 10 of this particular embodiment has a center section 12 and two end sections 14. The center section 12 may be generally rectangular but other suitable shapes will be apparent to those having ordinary skill in the art. The end sections 14 may have a generally triangular shape to provide the assembled ceiling display 10 with a three-dimensional configuration upon assembly. The edges of the end sections 14 may have one or more tabs 16 that serve to attach the end sections 14 to the center section 12. Double-sided tape, hook and loop fasteners, adhesives and the like may be used to attach the tabs 16 of the end sections 14 to the center section 12. Alternatively, the center section 12 and end sections 14 may be die-cut from a single piece of sheet material. Cutting the end sections 14 and center section 12 separately, however, may advantageously conserve material and prevent waste when cutting multiple center sections 12 and end sections 14 from a single sheet of material.

A lip 18 is attached around a portion of the perimeter of the center section 12 and the end sections 14. The lip 18 serves to hold the ceiling display 10 in a grid of a suspended ceiling. The interface between the lip 18 and the suspended ceiling will be described in greater detail below. The lip 18 may be attached around substantially the entire perimeter of the center section 12 and the end sections 14 or the lip 18 may be attached around on a portion of the center section 12 and the end sections 14 necessary to hold the ceiling display 10 in the suspended ceiling.

Fold lines 20 may be embossed at various locations on the center section 12 and end sections 24 to facilitate assembly of the ceiling display 10. For example, fold lines 20 may be embossed between the center section 12 and the lip 18, between the end sections 14 and the lip 18, or generally longitudinally across the center section 12.

The fold line 20 across the center section 12 serves to allow the center section 12 to be formed into an inverted tent-like shape. Attaching the tabs 16 of the end sections 14 to opposite edges of the folded center section 12 encloses the open ends of the tent-like shape and adds structural rigidity to the center section 12. In a preferred embodiment, the ceiling display 10 is assembled by removing protective paper from double-sided tape (not shown) that is affixed to the tabs 16. The exposed adhesive on the tabs 16 is joined to the edges of the center section 12 to form a rigid, multi-dimensional advertisement. The resulting ceiling display 10 may then be installed into the grid of a suspended ceiling.

Perforated lines 22 may be die cut into the end sections to facilitate installation of the ceiling display 12 into different sizes of grids. The most common sizes of grids are approximately 2 feet wide by 4 feet long or 2 feet wide by 2 feet long. Extenders 24 on each end section 14 may be folded along fold lines 20 such that the extenders 24 are generally parallel to the ceiling. This particular configuration fills the space in 2-foot by 4-foot grids. The lip 18 around the perimeter of the extenders 24 holds the ceiling display within the grid of the suspended ceiling. Alternatively, the extenders 24 may be removed from the end sections 14 by tearing along the perforated lines 22. If the extenders 24 are removed, the ceiling display 10 will fit within a 2-foot by 2-foot grid. The dimensions of the ceiling display 10 may be altered to accommodate installation in grids of varying dimension.

The outer surfaces of the center section 12 and the end sections 14 may be printed with advertisements or have other advertising material affixed to them. The center section 12 and end sections 14 may be screen printed or printed with a lithographic process, for example. Printed labels, adhesive sheets and the like may also be applied to the center section 12 and the end sections 14 to add color and product information to the ceiling display 10. The ceiling display 10 may also support electric motors or lights (not shown) of conventional design to further enhance the visibility of the ceiling display 10.

The ceiling display 10 may be configured to provide audio/visual advertising. In one embodiment, a flat panel display (not shown) may be attached to the center section 12 or end sections 14. The flat panel display may be a liquid crystal display (LCD), a plasma display or the like. The flat panel display may be battery powered and may be configured to display information transmitted from a remote source or a self-contained source such as a microchip. The flat panel display may display changeable still images or full motion video and the like. Additionally, one or more speakers (not shown) may be attached to the ceiling display 10 to produce sound.

The generally flat configuration of an unassembled ceiling display 10 also provides advantages to advertisers and storeowners. Consumers are attracted to advertisements that have interesting, multi-dimensional features. Multi-dimensional advertisements, however, are expensive to manufacture and transport. The ceiling display 10 in this particular embodiment of the invention is flat when unassembled. As a result, multiple unassembled ceiling displays 10 may be stacked and shipped together, thereby saving costs of shipping bulky displays. Storeowners may unobtrusively store the unassembled ceiling displays 10 on the store premises until the ceiling display 10 is needed. When needed, the ceiling display 10 may be assembled into a multi-dimensional advertisement and placed within the retail area of the store. The ceiling display 10 in this particular embodiment, therefore, has the handling advantages of a flat display and the advertising advantages of a multi-dimensional advertisement.

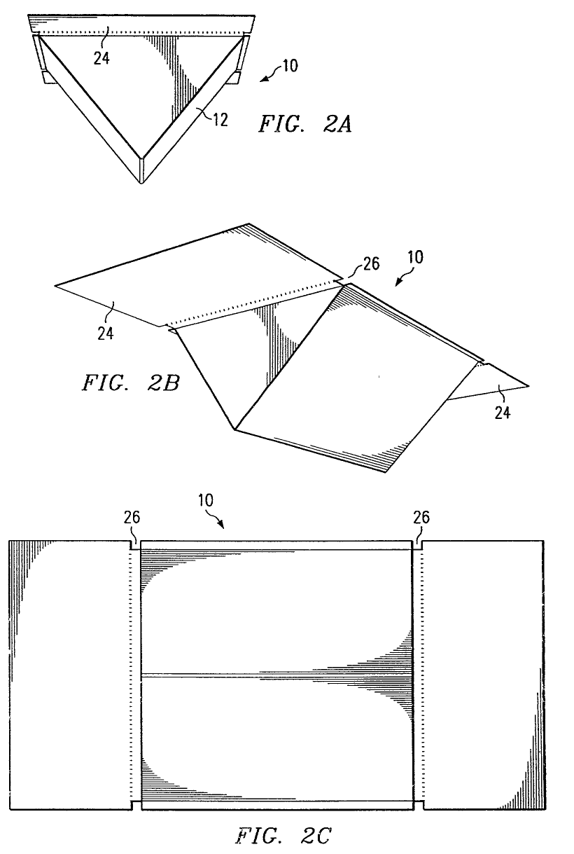

Turning now to FIGS. 2A-2C, an assembled ceiling display 10 is depicted. FIG. 2A depicts a perspective end view of the ceiling display 10 as it would appear to a consumer. As described above, the end section 14 may be printed with advertising material or color to enhance the appearance of the ceiling display 10. FIG. 2B depicts a perspective view of the assembled ceiling display 10 as viewed from an oblique angle. A notch 26 between the extender 24 and the end section 14 facilitates installation of the ceiling display 10 in the 2-foot by 2-foot configuration. FIG. 2C depicts the assembled ceiling display 10 from directly below.

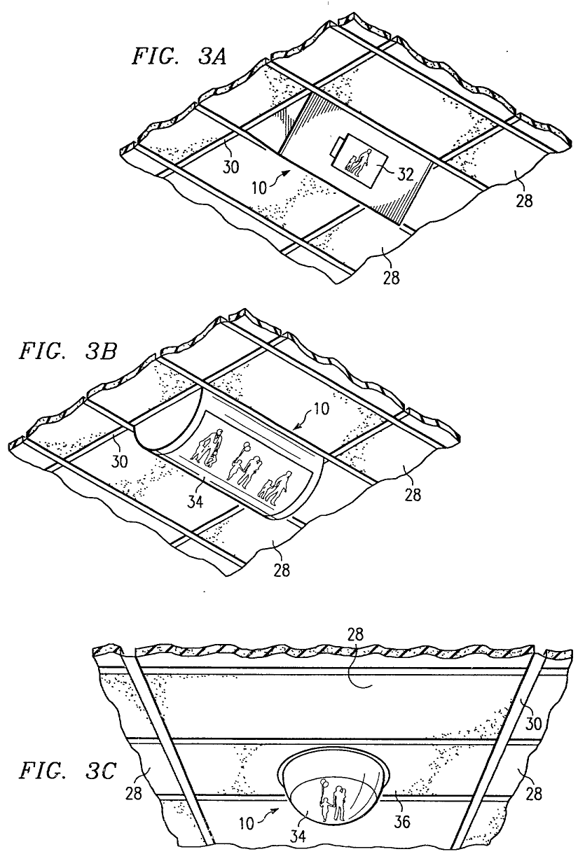

FIGS. 3A-3C depict various embodiments of the present invention that are installed in a suspended ceiling. The suspended ceiling has ceiling tiles 28 that are supported by a grid 30 that is suspended from a structural component of a building. In particular, FIG. 3A depicts a ceiling display 10 that has an attached lug-on 32. The lug-on 32 may be made from corrugated cardboard, plastic sheet and the like. The lug-on 32 may have a pattern, color or advertisement printed on the surface of the lug-on 32. The lug-on 32 further enhances the multidimensional appearance of the ceiling display 10 and serves to attract the attention of potential consumers. One or more lug-ons 32 may be attached to a surface of the ceiling display 10 using adhesive foam blocks (not shown), pegs, stand-offs and the like. Lug-ons 32 may also be attached to a surface of the ceiling display 10 using strings or springs to impart motion to the lug-on 32.

Turning now to FIG. 3B, the ceiling display 10 has an advertising piece 34 that is removably attached to the suspended ceiling by a lip (not shown) that is attached generally around the perimeter of the advertising piece 34. The lip (not shown) engages the grid 30 of the suspended ceiling. The advertising piece 34 may be configured in a variety of different shapes that will be apparent to those having ordinary skill in the art of fabricating advertising displays. In this particular embodiment, for example, the advertising piece 34 is a generally cylindrical shape. The advertising piece 34 may be made from corrugated cardboard, plastic sheet and the like. The surface of the advertising piece 34 may be a printed advertisement or have an applied adhesive label to advertise a particular product.

Another embodiment of the ceiling display 10 is depicted in FIG. 3C. In this particular embodiment the advertising piece 34 is a hemispherical shape that is attached to a panel 36. The panel 36 may have a lip (not shown) that secures the ceiling display 10 into the grid 30 of the suspended ceiling. The advertising piece may be vacuum-molded plastic, blow-molded plastic and the like. The advertising piece 34 may also be transparent or translucent to enhance the visual attributes of the ceiling display 10. A transparent or translucent advertising piece 34 may also transmit light from a source (not shown) within the ceiling display 10.

Referring now to FIG. 4, another embodiment of the present invention is depicted. The advertising piece 34 may be formed into the shape of an object such as a drink bottle, for example. The advertising piece 34 may be vacuum-molded plastic, blow-molded plastic and the like. The advertising piece 34 may be molded from colored plastic or it may also be painted or printed with advertising slogans or logos and the like.

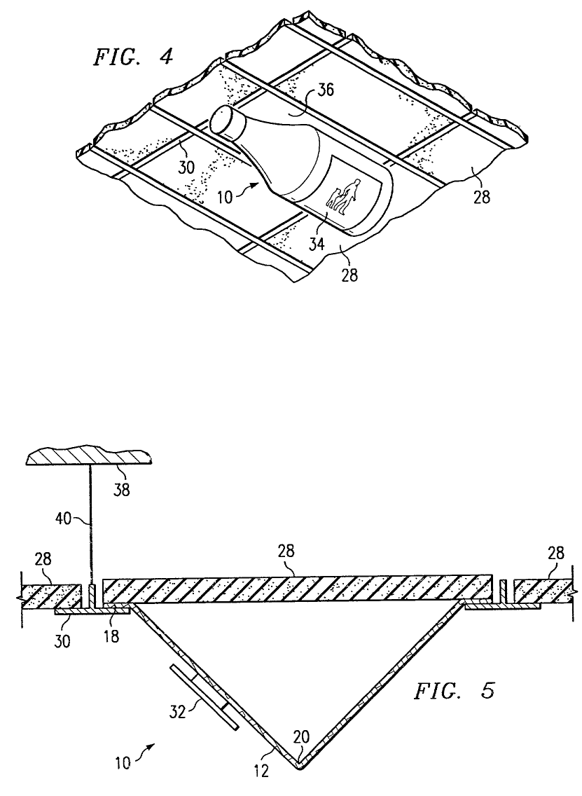

Turning now to FIG. 5, a detailed cutaway diagram of the ceiling display 10 installed in a suspended ceiling is depicted. Ceiling tiles 28 are suspended from a building structure 38 by the grid 30. The grid 30 is attached to the building structure 38 by a wire 40. To install the ceiling display 10 into the ceiling, an untrained store employee may assemble the ceiling display 10 as described above. The ceiling tile 28 is pushed upward to allow the lip 18 to be inserted between the ceiling tile 28 and the grid 30. The weight of the ceiling tile 28 on the lip 18 may act to secure the ceiling display 10 in place; however, a ceiling tile 28 is not required to install the ceiling display 10. Because the ceiling display 10 may be installed with the ceiling tile 28 in place, the store owner does not risk misplacing or damaging the ceiling tile 28 while the ceiling display 10 is being used. When the ceiling display 10 is discarded or moved, the ceiling display is easily removed from the suspended ceiling by dislodging the lip 18 from the grid 30. The ceiling tile 28 is unaffected and returns to its original position within the grid 30.

Whereas the invention has been shown and described in connection with the preferred embodiment thereof, it will be understood that many modifications, substitutions and additions may be made which are within the intended broad scope of the appended claims. There has therefore been shown and described an improved ceiling display tile that accomplishes at least all of the above stated advantages.

What is claimed is:

1. A ceiling display comprising:
a generally rectangular panel;
a lip attached generally around a portion of the perimeter of the panel, the lip receivable by the grid of a suspended ceiling; and
an advertisement attached to the panel.

2. The ceiling display of claim 1 wherein the panel is corrugated cardboard.

3. The ceiling display of claim 1 wherein the advertisement is an advertisement piece that is a three-dimensional molded shape.

4. The ceiling display of claim 1 wherein the advertisement is screen-printed.

5. The ceiling display of claim 1 wherein the advertisement is printed using a lithographic process.

6. The ceiling display of claim 1 further comprising a lug-on piece attached to the panel.

7. The ceiling display of claim 1 further comprising at least one notch cut in the lip to facilitate installation of the ceiling display in a grid of a suspended ceiling.

8. An advertising system comprising:
a suspended ceiling having one or more ceiling tiles suspended by a grid;
a ceiling display; and
a lip attached to the ceiling display and removably attaching the ceiling display to the grid.

9. The system of claim 8 wherein the ceiling tiles are approximately 2 feet wide and 4 feet long.

10. The system of claim 8 wherein the ceiling tiles are approximately 2 feet wide and 2 feet long.

11. The system of claim 8 wherein the ceiling display is made from corrugated cardboard.

12. The system of claim 8 wherein the ceiling display is made from a single piece of material.

13. The system of claim 8 wherein the ceiling display generally extends from the plane of the suspended ceiling.

14. A ceiling display comprising:
a generally rectangular, foldable center section;
a lip attached to and extending from a first edge and a second edge of the center section, the first edge opposite the second edge; and
a first end section attached to a third edge of the center section and a second end section attached to a fourth edge of the center section.

15. The ceiling display of claim 14 wherein the center section is folded along a line generally parallel to the first edge and the second edge, the fold generally dividing the third edge and the fourth edge into generally equal halves.

16. The ceiling display of claim 14 wherein the end sections have extenders.

17. The ceiling display of claim 14 wherein the extenders are removable from the end sections.

18. The ceiling display of claim 14 wherein one or more lug-ons are attached to the ceiling display.

19. The ceiling display of claim 14 wherein the surfaces of the end sections and the center section are printed.

20. The ceiling display of claim 14 wherein the end sections are attached to the center section with double-sided tape.
